(19) United States
(12) Patent Application Publication
(10) Pub. No.: US 2017/0235029 A1
(43) Pub. Date: Aug. 17, 2017

(54) PRISM SHEET, CURVED BACKLIGHT SOURCE AND DISPLAY DEVICE

(71) Applicants: BOE TECHNOLOGY GROUP CO., LTD., Beijing (CN); BEIJING BOE DISPLAY TECHNOLOGY CO., LTD., Beijing (CN)

(72) Inventors: Kai Diao, Beijing (CN); Park Inho, Beijing (CN); Liang Zhang, Beijing (CN); Haijun Shi, Beijing (CN); Hongyu Zhao, Beijing (CN)

(21) Appl. No.: 14/907,176

(22) PCT Filed: Jun. 25, 2015
(86) PCT No.: PCT/CN2015/082329

§ 371 Date: Jan. 22, 2016

(30) Foreign Application Priority Data
Jan. 5, 2015 (CN) 201510002363.3

(51) Int. Cl. G02B 5/04; F21V 8/00

(52) U.S. Cl. CPC G02B 5/045; G02B 6/0053

(57) ABSTRACT

A prism sheet, a curved backlight source and a display device are disclosed. The prism sheet includes a substrate and a plurality of prism units arranged on the substrate in an array. Each of the prism units has a triangular cross-section which has a first base angle and a second base angle, and both the first base angle and the second base angle are at a side of the cross-section close to the substrate. The degrees of the first and second base angles of the triangular cross-section of at least one of the plurality of prism units are different from each other. By means of the prism sheet, the backlight source and the display device according to the embodiments of the present invention, the uniformity of brightness of the emitted light may be improved, the visual angle may be increased, and as a result, the visual effect may be improved.

### CROSS-REFERENCE TO RELATED APPLICATION

This application claims the benefit of Chinese Patent Application No. 201510002363.3 filed on Jan. 5, 2015 in the State Intellectual Property Office of China, the whole disclosure of which is incorporated herein by reference.

### BACKGROUND OF THE INVENTION

Field of the Invention

The present disclosure relates to a display field, in particular, to a prism sheet, a curved backlight source and a display device.

Description of the Related Art

In a display device, it is common to provide a prism sheet on a light emitting surface of a light guide plate or a diffusion plate in order to make the light emitting from a backlight source uniform. Each of prism units on an existing prism sheet has equal angles. If such prism sheet is applied in a curved backlight source, it enables emergent light to converge towards a center of a display area, as shown in FIG. 1, thereby causing the brightness and the visible angle of the emergent light to become small and thus affecting visual effect. With the development of the curved display device, the curved backlight source is more and more widely used. Therefore, a prism sheet which is suitable for the curved backlight source is required.

### SUMMARY OF THE INVENTION

An object of the present disclosure is to provide a prism sheet which is capable of increasing the brightness and visual angle of the curved backlight source and thus improving the display effect.

Another object of the present disclosure is to provide a curved backlight source and a display device comprising the above prism sheet.

In order to reach the above objects of the present disclosure, the technical solutions of the present disclosure are accomplished by the following means:

An embodiment of the present invention provides a prism sheet comprising:

a substrate;

a plurality of prism units arranged on the substrate in an array, each of the prism units having a triangular cross-section which has a first base angle and a second base angle, both the first base angle and the second base angle being at a side of the cross-section close to the substrate,

wherein degrees of the respective first and second base angles of the triangular cross-section of at least one of the plurality of prism units are different from each other.

In an embodiment, the plurality of prism units are arranged in a first direction which is perpendicular to axial directions of the prisms, and the first base angle of the triangular cross-section of each of the prism units is directed toward the first direction, and the second base angle of the triangular cross-section of each of the prism units is directed toward a second direction opposite to the first direction.

In an embodiment, the ratios of degrees of the first base angle to degrees of the second base angles of the respective prism units are successively increased or reduced in the first direction.

In an embodiment, the degrees of the first base angles of the respective prism units are successively increased in the first direction and the degrees of the second base angles of the respective prism units are successively reduced in the first direction.

In an embodiment, the respective ratios of degrees of the first base angles to degrees of the second base angles of the prism units on a side of the prism sheet from the prism unit located centrally on the prism sheet towards the first direction are equal, and/or the respective ratios of degrees of the first base angles to degrees of the second base angles of the prism units on a side of the prism sheet from the prism unit located centrally on the prism sheet towards the second direction are equal.

In an embodiment, the first base angle and the second angle of the prism unit located centrally on the prism sheet have equal degrees.

In an embodiment, the degrees of the first and second base angles of the prism units are in a range of 10 degrees to 80 degrees.

In an embodiment, the substrate and the prism units are formed integrally or formed individually.

An embodiment of the present invention further provides a curved backlight source comprising the prism sheet according to any one of the above embodiments.

In an embodiment, the curved backlight source further comprises:

a curved light guide plate having a light incident surface and a light emitting surface, the prism sheet being arranged on the light emitting surface;

a light source, light emitting from the light source shooting into the curved light guide plate from the light incident surface at a side of the curved light guide plate, all of the prism units on the prism sheet being arranged in a direction along which the light shoots into the curved light guide plate,

wherein the ratio of degree of the first base angle to degree of the second base angle of each of the prism units is determined depending on the curvature of the curved light guide plate, or both the degrees of the first and second base angles of each of the prism units themselves are determined depending on the curvature of the curved light guide plate.

In an embodiment, the curved backlight source further comprises:

a curved diffusion plate having a light incident surface and a light emitting surface, the prism sheet being arranged on the light emitting surface;

a light source, light emitting from the light source shooting into the curved diffusion plate from the light incident surface at a bottom of the curved diffusion plate, all of the prism units on the prism sheet being arranged in a direction perpendicular to a direction along which the light shoots into the curved diffusion plate,

wherein the ratio of degree of the first base angle to degree of the second base angle of each of the prism units is determined depending on the curvature of the curved diffusion plate, or both the degrees of the first and second base angles of each of the prism units themselves are determined depending on the curvature of the curved diffusion plate.

An embodiment of the present invention further provides a display device comprising the prism sheet according to any one of the above embodiments or the curved backlight source according to any one of the above embodiments.

At least one aspect of the above solutions of the present invention can compensate the converging effect of the emitted light due to the curvature of the light guide plate or the diffusion plate in the curved backlight source by means of an asymmetrical design of the prism unit. By means of the prism sheet, the backlight source and the display device according to the embodiments of the present invention, the uniformity of brightness of the emitted light may be improved, the visual angle may be increased, and as a result, the visual effect may be improved.

### BRIEF DESCRIPTION OF THE DRAWINGS

FIG. 1 is a schematic view of a prism sheet provided in a curved backlight source in the prior art;

FIG. 2 is a schematic view of a prism sheet in a horizontal placement state according to an embodiment of the present invention;

FIG. 3 is a schematic view of the prism sheet provided in a curved backlight source according to the embodiment of the present invention;

FIG. 4a is a schematic view showing a propagation path of light in the prism sheet in the prior art; and

FIG. 4b is a schematic view showing a propagation path of light in the prism sheet according to the embodiment of the present invention.

### DETAILED DESCRIPTION OF PREFERRED EMBODIMENTS OF THE INVENTION

The technical solutions of the present invention will be further described in detail by means of the following embodiments and in combination with the drawings. The same or similar reference numerals indicate the same or similar element throughout the specification. The following description of implementations of the present invention with reference to the drawings is intended to explain the general concept of the present invention, rather than being understood as limiting the present invention.

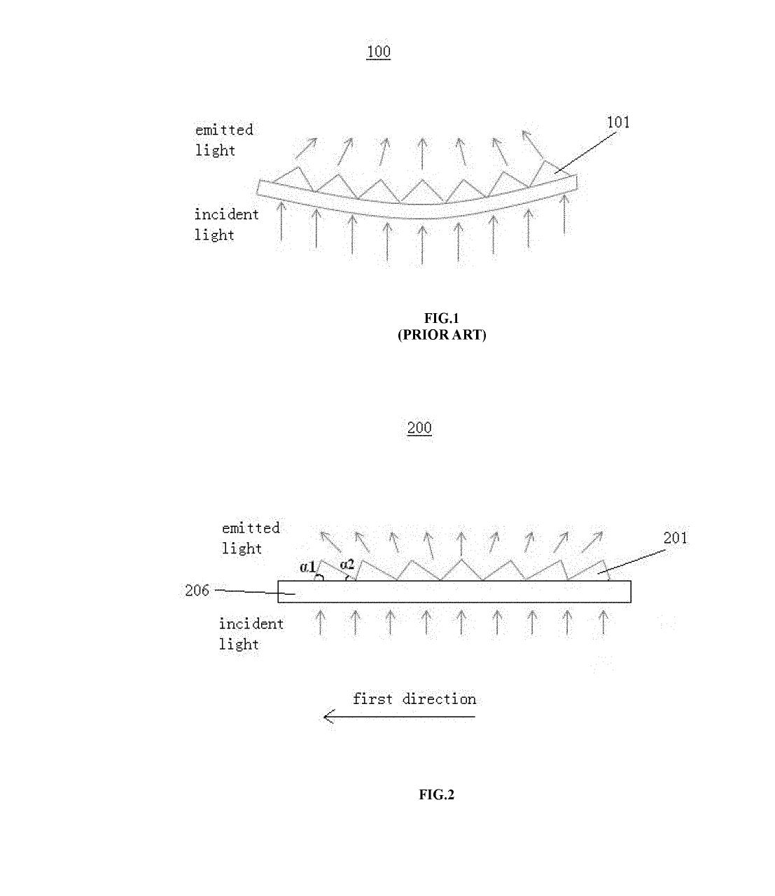

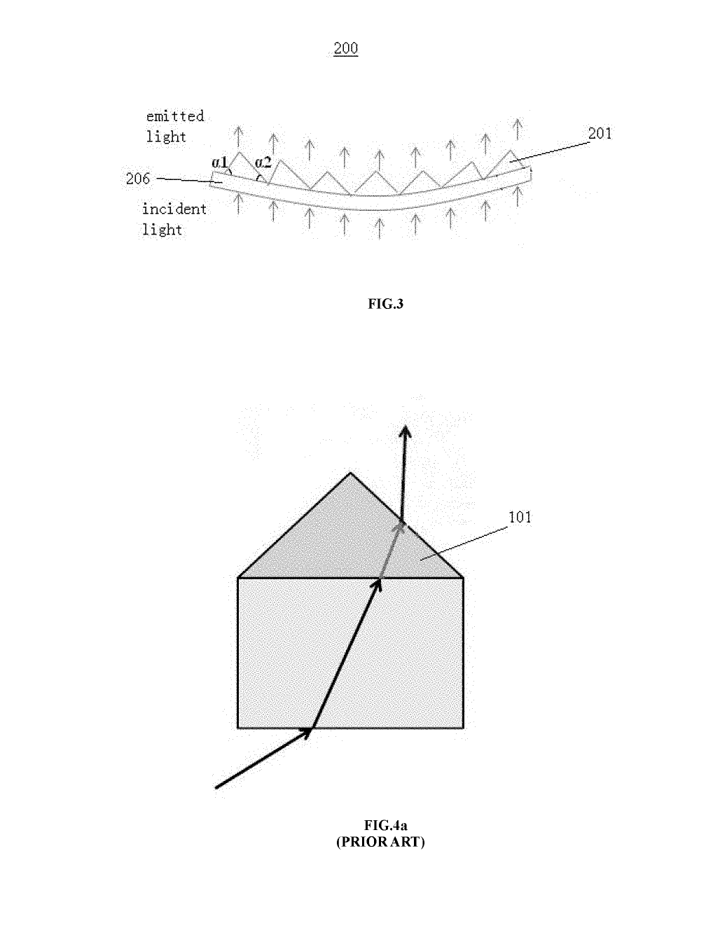

FIGS. 2 and 3 schematically show a prism sheet 200 according to an embodiment of the present invention. The prism sheet 200 comprises a substrate 206 and a plurality of prism units 201 arranged on the substrate 206 in an array. Each of the prism units 201 has a triangular cross-section having a first base angle α1 and a second base angle α2 (for example, may also have an apex angle). Both the first and second base angles α1, α2 are positioned at a side of the cross-section close to the substrate 206. The first base angle α1 of the triangular cross-section of at least one of the plurality of prism units 201 may be different from the second base angle α2 thereof.

In contrast, in a prism sheet 100 in the prior art as shown in FIG. 1, each of prism units 101 is designed to have the same symmetrical cross-section (that is, two base angles thereof are equal). The prism sheet 100 will be bent as it is assembled into a curved backlight source, which causes incident directions of light are not the same for the prism units 101, and the prism units 101 each is designed to have the same symmetrical cross-section, so that actual directions of light emission will also be different. In the case where the prism sheet 100 is bent from both sides towards a central portion thereof, as shown in FIG. 1, the directions of light emission will be converged towards a center of a display area.

As previously described, in the prism sheet 200 according to the embodiment of the present invention, the prism unit 201 is designed to have an asymmetric cross-section, that is, the two base angles of the cross-section are not equal to each other, which enables the emitted light to produce a certain deflection, as compared to the prism unit 101 in the prior art, thereby compensating an influence on the prism sheet by the curved backlight source.

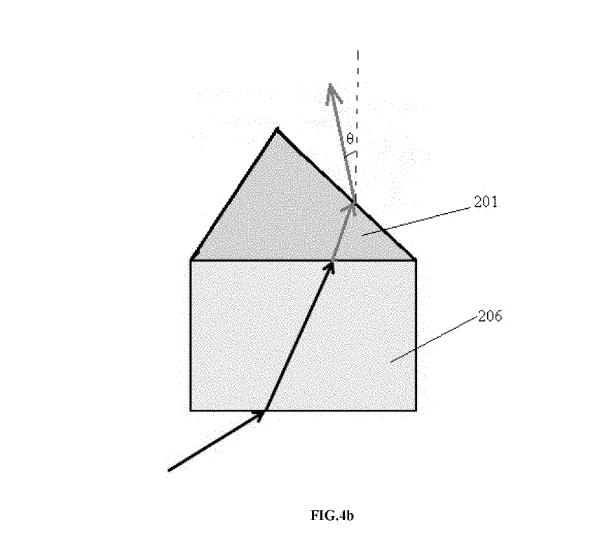

As an example, FIGS. 4a and 4b show propagation paths of light in the prism sheet 100 in the prior art and in the prism sheet 200 according to the embodiment of the present invention, as indicated by arrows. Referring to FIGS. 4a and 4b, according to the refraction principle, the emitted light will be deflected by an angle θ in the prism sheet 200 having an asymmetrical design according to the embodiment of the present invention, as compared to the prism sheet 100 in the prior art. As a result, the deflection of the emitted light due to bending of a light guide plate or a diffusion plate, when the prism sheet is applied in the curved backlight source, may be compensated. The emitted light may be emitted towards a desired direction, for example, emitted in a direction perpendicular to the display area, by setting appropriate values of the first and second base angles α1, α2.

It should be noted that, although the incident direction of the incident light is substantially perpendicular to the prism sheet 200 placed horizontally in FIGS. 2 and 3, it is merely illustrative, and the incident direction of the incident light is not limited thereto, for example, it may be inclined with regard to an incident surface of the prism sheet 200 at any angle.

In addition, in the prism sheet 200 according to the embodiment of the present invention, each of the prism units 201 may have an asymmetrical design, that is, the cross-section of each of the prism units 201 has the first base angle α1 and the second base angle α2, which are not equal to each other. Alternatively, some (for example, three, five, ten, etc.) of the prism units 201 may have an asymmetrical design. This is because the light guide plate or the diffusion plate in the curved backlight source may have a variety of designs in practice, for example, they may be bent entirely in a uniform curvature, or may be bent partially in a uniform curvature, or even may be bent for different sections in different curvatures.

In an example, the plurality of prism units 201 may be arranged in an array in a first direction which is perpendicular to an axial direction of each of the prism units, for example, the direction as indicated by the arrow in FIG. 2. The first base angle α1 of the triangular cross-section of each of the prism units 201 is directed towards the first direction, and the second base angle α2 of the triangular cross-section of each of the prism units 201 is directed towards the second direction which is opposite to the first direction.

It should be noted that, although the first direction is shown as a leftward direction in FIG. 2, it is merely illustrative and not limited to this, for example, the first direction may be a rightward direction in FIG. 2.

As an example, degrees of the first and second base angles α1, α2 of each of the prism units 201 may be determined based on an actual curvature of the light guide plate or the diffusion plate in the curved backlight source and a designed direction of the incident light. For example, ratios of degrees of the first base angles α1 to degrees of the second base angles α2 of the respective prism units 201 may be set to be increasing or decreasing in the first direction. As an example, the first base angles α1 of the respective prism units 201 may be increased successively in the first direction and the second angles α2 thereof may be decreased successively in the first direction. For example, as shown in FIGS. 2 and 3, the first base angles α1 of the respective prism units 201 may be decreased successively from left to right, and the second angles α2 of the respective prism units 201 may be increased successively from right to left. Thus, ratios of degrees of the first base angles α1 to degrees of the second base angles α2 of the respective prism units 201 may be decreased successively from left to right, or increased successively from right to left. It is advantageous to compensate the directions of the emitted light based on inclination degrees of the prism units 201 at different positions in the curved backlight source. In another example, ratios of degrees of the first base angles α1 to degrees of the second base angle α2 of the respective prism units 201 on a side of the prism sheet from the central prism unit towards the first direction may be set to be equal to each other, and/or ratios of degrees of the first base angles α1 to degrees of the second base angles α2 of the respective prism units 201 on a side of the prism sheet from the central prism unit towards the second direction may be set to be equal to each other. It can increase machinability of the prism sheet.

As an example, only some of the prism units 201 on the prism sheet 200 may have a symmetrical design, that is, the first base angle α1 is equal to the second base angle α2. This is because the directions of light emitted from all of the prism units 201 may be not always changed while the light guide plate or the diffusion plate in the curved backlight source is bent. For example, the first and second base angles α1, α2 of the prism unit 201 located centrally on the prism sheet 200 are equal to each other, as shown in FIGS. 2 and 3. It ensures that the prism unit 201 located centrally guides the emitted light towards the center of the display area when the prism sheet 200 is placed in the curved backlight source.

As an example, both the first base angle α1 and the second base angle α2 may be in a range of 10 degrees to 80 degrees, for example, in a range of 30 degrees to 60 degrees. However, the first base angle α1 and the second base angle α2 are not limited to these degrees, and may be selected as any value in a range of 0 degree to 90 degrees as design required. If the light guide plate or the diffusion plate in the curved backlight source has a large curvature, the first and second base angles α1, α2 of some of the prism units 201 may be valued larger than 90 degrees, but smaller than 180 degrees.

As an example, in the prism sheet 200 according to the embodiment of the present invention, the substrate 206 may be integrated with the prism units 201, or the substrate 206 and the prism units 201 may be formed individually, for example, the substrate 206 and the prism units 201 may be bonded together after they are individually formed. The substrate 206 enables the prism units 201 to be supported more stably.

An embodiment of the present invention further provides a curved backlight source which comprises the prism sheet 200 according to any one of the above embodiments. As an example, the curved backlight source may be a side-type curved backlight source which may comprise: a curved light guide plate having a light incident surface and a light emitting surface, the prism sheet being arranged on the light emitting surface; a light source, light emitted from the light source shooting into the curved light guide plate from the light incident surface at a side of the light guide plate, the prism units on the prism sheet being arranged in a direction along which the light shoots into the curved light guide plate. The ratio (i.e. a degree of asymmetry) of degree of the first base angle α1 to degree of the second base angle α2 of each of the prism units 201 is determined depending on the curvature of the curved light guide plate.

In another embodiment, the curved backlight source may be a direct-type curved backlight source which may comprise: a curved diffusion plate having a light incident surface and a light emitting surface, the prism sheet being arranged on the light emitting surface; a light source, light emitted from the light source shooting into the curved diffusion plate from the light incident surface at a bottom of the diffusion plate, the prism units on the prism sheet being arranged in a direction perpendicular to a direction along which the light shoots into the curved diffusion plate. The ratio of degree of the first base angle α1 to degree of the second base angle α2 of each of the prism units 201 is determined depending on the curvature of the curved diffusion plate.

In the above examples, the prism sheet 200 may be increasingly adapted to the curved degree of the curved backlight source so as to make the brightness of the emitted light more uniform. As an example, the degrees of the first and second base angles α1, α2 themselves may also be determined depending on the curvature of the light guide plate or the diffusion plate in the curved backlight source.

In the above examples, the prism sheet is positioned on the light emitting surface of the light guide plate or the diffusion plate. Alternatively, as an example, the prism sheet 200 may also be positioned on the light incident surface of the light guide plate or the diffusion plate.

An embodiment of the present invention further provides a display device comprising the prism sheet 200 according to any one of the above embodiments or the curved backlight source according to any one of the above embodiments.

By means of the prism sheet, the backlight source and the display device according to the embodiments of the present invention, the uniformity of brightness of the emitted light may be improved, the visual angle may be increased, and as a result, the visual effect may be improved.

While the embodiments of the present invention have been described in combination with the drawings, the embodiments with reference to the drawings are intended to explain preferable implementations of the present invention, rather than being understood as limiting the present invention.

Although certain embodiments according to the general concept of the present invention have been shown and described, changes can be made to these embodiments by those skilled in the art without departing from the principle and spirit of the present invention. Thereby, the scope of the present invention is defined by appended claims and equivalents thereof.

1. A prism sheet comprising:
a substrate; and
a plurality of prism units arranged on the substrate in an array, each of the prism units having a triangular cross-section which has a first base angle and a second base angle, both the first base angle and the second base angle being at a side of the cross-section close to the substrate,
wherein the degrees of the respective first and second base angles of the triangular cross-section of at least one of the plurality of prism units are different from each other.

2. The prism sheet according to claim 1, wherein the plurality of prism units are arranged in the array in a first direction which is perpendicular to axial directions of the prisms, and wherein the first base angle of the triangular cross-section of each of the prism units is directed toward the first direction, and the second base angle of the triangular cross-section of each of the prism units is directed toward a second direction opposite to the first direction.

3. The prism sheet according to claim 2, wherein ratios of degrees of the first base angles to degrees of the second base angles of the respective prism units are successively increased or reduced in the first direction.

4. The prism sheet according to claim 2, wherein degrees of the first base angles of the respective prism units are successively increased in the first direction and degrees of the second base angles of the respective prism units are successively reduced in the first direction.

5. The prism sheet according to claim 2, wherein the respective ratios of degrees of the first base angles to degrees of the second base angles of the prism units on a side of the prism sheet from the prism unit located centrally on the prism sheet towards the first direction are equal, and/or the respective ratios of degrees of the first base angles to degrees of the second base angles of the prism units on a side of the prism sheet from the prism unit located centrally on the prism sheet towards the second direction are equal.

6. The prism sheet according to claim 1, wherein the first base angle and the second angle of the prism unit located centrally on the prism sheet have equal degrees.

7. The prism sheet according to claim 1, wherein the degrees of the first and second base angles of the prism units are in a range of 10 degrees to 80 degrees.

8. The prism sheet according to claim 1, wherein the substrate and the prism units are formed integrally or formed individually.

9. A curved backlight source comprising the prism sheet according to claim 1.

10. The curved backlight source according to claim 9, further comprising:
a curved light guide plate having a light incident surface and a light emitting surface, the prism sheet being arranged on the light emitting surface; and
a light source, light emitted from the light source shooting into the curved light guide plate from the light incident surface at a side of the curved light guide plate, all of the prism units on the prism sheet being arranged in a direction along which the light shoots into the curved light guide plate,
wherein the ratio of degree of the first base angle to degree of the second base angle of each of the prism units is determined depending on the curvature of the curved light guide plate, or both the degrees of the first and second base angles of each of the prism units themselves are determined depending on the curvature of the curved light guide plate.

11. The curved backlight source according to claim 9, further comprising:
a curved diffusion plate having a light incident surface and a light emitting surface, the prism sheet being arranged on the light emitting surface; and
a light source, light emitted from the light source shooting into the curved diffusion plate from the light incident surface at a bottom of the curved diffusion plate, all of the prism units on the prism sheet being arranged in a direction perpendicular to a direction along which the light shoots into the curved diffusion plate,
wherein the ratio of degree of the first base angle to degree of the second base angle of each of the prism units is determined depending on the curvature of the curved diffusion plate, or both the degrees of the first and second base angles of each of the prism units themselves are determined depending on the curvature of the curved diffusion plate.

12. A display device comprising:
a prism sheet that comprises:
a substrate; and
a plurality of prism units arranged on the substrate in an array, each of the prism units having a triangular cross-section which has a first base angle and a second base angle, both the first base angle and the second base angle being at a side of the cross-section close to the substrate,
wherein the degrees of the respective first and second base angles of the triangular cross-section of at least one of the plurality of prism units are different from each other.
or:
the curved backlight source according to claim 9.

13. The prism sheet according to claim 2, wherein the first base angle and the second angle of the prism unit located centrally on the prism sheet have equal degrees.

14. The prism sheet according to claim 3, wherein the first base angle and the second angle of the prism unit located centrally on the prism sheet have equal degrees.

15. The prism sheet according to claim 4, wherein the first base angle and the second angle of the prism unit located centrally on the prism sheet have equal degrees.

16. The prism sheet according to claim 5, wherein the first base angle and the second angle of the prism unit located centrally on the prism sheet have equal degrees.

17. The prism sheet according to claim 2, wherein the degrees of the first and second base angles of the prism units are in a range of 10 degrees to 80 degrees.

18. The prism sheet according to claim 3, wherein the degrees of the first and second base angles of the prism units are in a range of 10 degrees to 80 degrees.

19. The prism sheet according to claim 4, wherein the degrees of the first and second base angles of the prism units are in a range of 10 degrees to 80 degrees.

20. The prism sheet according to claim 5, wherein the degrees of the first and second base angles of the prism units are in a range of 10 degrees to 80 degrees.
